(19) United States
(12) Patent Application Publication
(10) Pub. No.: US 2002/0098314 A1
(43) Pub. Date: Jul. 25, 2002

(54) Stencil sheet, process for producing the same, and process for producing stencil plate

(75) Inventor: Koichi Uchiyama, Tokyo (JP)

Correspondence Address: Richard J. Minnich, Esq., Fay, Sharpe, Fagan, Minnich & McKee, LLP, Seventh Floor, 1100 Superior Avenue, Ceveland, OH, 44114-2518, US

(73) Assignee: Riso Kagaku Corporation

(21) Appl. No.: 10/051,786

(22) Filed: Jan. 17, 2002

(30) Foreign Application Priority Data
Jan. 19, 2001 (JP) 2001-012088

(51) Int. Cl. B32B 3/26; B29C 59/04

(52) U.S. Cl. 428/63; 264/156; 264/259

(57) ABSTRACT

Disclosed are a stencil sheet which can smoothly and accurately be perforated even by a small amount of energy while having a required strength and a stencil plate produced from which is easy to control the amount of an ink to be dislocated to an object to be printed and has such an advantage that setoff is small, printability and definition of printed images are excellent, jamming is not caused, and wrinkles are not formed when stencil printing is performed by using the stencil plate; a process for producing the stencil sheet; and a process for producing a stencil plate;

the stencil sheet comprising a sheet having a large number of minute perforations, the minute perforations being filled with the following resin (A), (B), or (C).

(A) a resin having a melting point lower than that of the sheet

(B) a resin which is soluble in a solvent

(C) a heat adhesive resin

### TECHNICAL FIELD

The present invention relates to a stencil sheet, a process for producing the stencil sheet, and a process for producing a stencil plate. More specifically, the present invention relates to i) a stencil sheet which can be perforated by a small amount of energy while maintaining a high strength and high sensitivity of the stencil sheet and thus simplification of a stencil printing apparatus can be devised, ii) a process for producing the stencil sheet, and iii) a process for producing a stencil plate from the stencil sheet.

In the present specification and claims, the term “stencil sheet” is intended to mean a master sheet which is used for producing a stencil plate, and the term “stencil plate” is intended to mean a sheet in a state wherein the sheet can be used for stencil printing operation as it is.

### BACKGROUND ART

As stencil sheets, sheets having a structure in which a porous support such as a tissue paper (thin paper), non-woven fabric, and gauze produced from natural fibers, chemical fibers, synthetic fibers, or their mixture is adhered onto a film of a crystalline thermoplastic resin such as a polyester, polyvinylidene chloride, polyethylene, and polypropylene with an adhesive are used from some time ago (as disclosed, for example, in Laid-open Japanese Patent Publication Nos. Sho 51-2512 and Sho 57-182495).

When these stencil sheets are used, production of stencil plates is performed by directing or adding heat energy to the portions in the thermoplastic resin films which portions correspond to letters or pictures (hereinafter sometimes referred to as images) to be printed, to melt the portions, thereby forming perforations in the films. Accordingly, the amount of energy necessary for producing such stencil plates is decided by the thickness of thermoplastic resin films when the films are the same material. Whereas at least a certain thickness of the films is necessary to maintain durability of the films, it is necessary for the films to reduce their thickness in order to increase the sensitivity to perforating. As will be understood from the foregoing, there are mutually contradicting requirements in the thickness of thermoplastic resin films required from the strength and from the sensitivity to perforating of the films, and it was difficult to satisfy both of the requirements at the same time. Further, in order to produce stencil plates, it is necessary to add heat energy of a certain amount or more to thermoplastic resin films to melt particular portions of the films, thereby forming perforations therein. Thus, it was difficult to reduce the amount of the energy used for perforating.

### DISCLOSURE OF THE INVENTION

An object of the present invention is to resolve the problems in the prior art described above. Another object of the present invention is to provide

i) a stencil sheet which can smoothly and accurately be perforated by a small amount of energy (in other words, which has an excellent perforatability) while having a required strength,

a stencil plate produced from which stencil sheet is easy to control the amount of an ink to be dislocated to an object to be printed and has such advantages that setoff is small, that printability and definition of printed images are excellent, and that jamming of the plate is not caused in a stencil printing apparatus during feeding and wrinkles are not formed on the plate at the time of winding around or loaded on a printing drum (in other words, the stencil plate is excellent in feedability and loadability) when stencil printing is performed by using the plate,

ii) a process for producing the stencil sheet, and

iii) a process for producing a stencil plate from the stencil sheet.

As a result of the diligent investigations by the present inventors, it has now been found that the objects of the present invention described above can be achieved by preparing in advance a sheet having a large number of minute perforations through which an ink can be forced to pass, filling, as filler, a material having a specific characteristic different from that of the sheet in the minute perforations, and then removing the filler only at the portions corresponding to the printed images in a manuscript to form minute perforations in the sheet at a time of producing a stencil plate, leading to the accomplishment of the present invention.

In order to achieve the objects described above, the present invention is summarized as follows:

(1) A stencil sheet comprising a sheet having a large number of minute perforations, the minute perforations being filled with the following resin (A), (B), or (C), as filler.

(A) a resin having a melting point lower than that of the sheet,

(B) a resin which is soluble in a solvent

(C) a heat adhesive resin

(2) The stencil sheet recited in paragraph (1) above wherein the sheet is a film of a synthetic resin.

(3) The stencil sheet recited in paragraph (1) or (2) above wherein the area fraction of the opening portions of the minute perforations is in the range of 20 to 70% and the diameters of equivalent circles are in the range of 5 to 200 μm when the opening portions are assumed to be circular in shape.

(4) The stencil sheet recited in paragraph (1) or (2) above wherein the minute perforations in the sheet are trapezoidal in vertical cross section.

(5) The stencil sheet recited in paragraph (1) or (2) above wherein the thickness of the sheet is in the range of 1.5 to 20 μm.

(6) The stencil sheet recited in paragraph (1) or (2) above wherein the stencil sheet further comprises a porous support laminated on one side of the sheet.

(7) A process for producing a stencil sheet comprising pressing a roller having drill-like projections formed on its surface against a film of a synthetic resin to form minute perforations and then filling the minute perforations with a filler.

(8) The process for producing a stencil sheet recited in paragraph (7) above wherein filling of the minute perforations with the filler is performed by applying a solution or emulsion of a resin as filler on the film of a synthetic resin having minute perforations formed therein, squeezing the solution or emulsion with a squeegee to force it into the minute perforations, and then solidifying the solution or emulsion of the resin.

(9) The process for producing a stencil sheet recited in paragraph (7) above wherein the process further comprises laminating a porous support on one side of the film after a roller having drill-like projections formed on its surface was pressed against the film of a synthetic resin to form minute perforations and the minute perforations were filled with the filler or resin.

(10) The process for producing a stencil sheet recited in paragraph (7) or (8) above wherein the filler or resin is selected from the group consisting of the following resins (A), (B), and (C).

(A) a resin having a melting point lower than that of the film

(B) a resin which is soluble in a solvent

(C) a heat adhesive resin

(11) The process for producing a stencil sheet recited in paragraph (7) or (8) above wherein the film has an area fraction of the opening portions of the minute perforations in the range of 20 to 70% and diameters of equivalent circles in the range of 5 to 200 μm when the opening portions are assumed to be circular in shape.

(12) The process for producing a stencil sheet recited in paragraph (7) or (8) above wherein the minute perforations in the film are trapezoidal in vertical cross section.

(13) The process for producing a stencil sheet recited in paragraph (7) or (8) above wherein the film has a thickness in the range of 1.5 to 20 μm.

(14) A process for producing a stencil plate comprising subjecting a stencil sheet

which was obtained by pressing a roller having drill-like projections formed on its surface against a film of a synthetic resin to form minute perforations in the film and then filling the minute perforations with the following resin (A), (B), or (C) as filler

(A) a resin having a melting point lower than that of the film,

(B) a resin which is soluble in a solvent

(C) a heat adhesive resin

to the following treatment (a), (b), or (c) according to the resin used, respectively, so that the resin in the minute perforations only at the portions corresponding to the printed images or specified portions in a manuscript are removed from the film.

(a) When the resin is (A), an amount of heat energy is added to the surface of the film of the stencil sheet to melt the resin.

(b) When the resin is (B), a liquid which dissolves the resin is applied or added onto the surface of the film of the stencil sheet to dissolve the resin.

(c) When the resin is (C), a manuscript is pressed against the surface of the film of the stencil sheet while being heated to adhere the resin to the manuscript.

### BRIEF DESCRIPTION OF THE DRAWINGS

FIG. 1 is a schematic drawing for illustrating a process for producing an example of the stencil sheets of the present invention.

FIG. 2 is a schematic drawing for illustrating the cross section of another example of the stencil sheets of the present invention.

In the drawings, 1 is a synthetic resin film in which minute perforations are formed, 2 is a minute perforation, 3 is a polypropylene sheet, 4 is a filler, 5 is a squeegee, 6 is a stencil sheet, 7 is a synthetic resin film having minute perforations in some of which perforations a filler is filled, 8 is a porous support, 9 is a minute perforation (through which an ink is forced to pass), and 10 is another stencil sheet.

In the stencil sheet of the present invention, a large number of minute perforations through which an ink can be forced to pass are formed, (i) a resin having a melting point lower than that of the sheet, (ii) a resin soluble in a solvent, or (iii) a heat adhesive resin is filled, as filler, in the minute perforations, and the resin in the minute perforations at the portions, for example, the portions corresponding to printed images in a manuscript can be removed by melting, dissolving, or adhering according to the characteristic of the filler. Accordingly, the stencil sheet of the present invention can be perforated to form a stencil plate by a small amount of energy compared with conventional methods in which a thermoplastic resin film itself is melted at predetermined portions to form perforations. Besides, since the sensitivity to perforating are not substantially dependent on the thickness of the sheet in the stencil sheet of the present invention, it is possible to satisfy the strength and sensitivity of the sheet at the same time. Further, since the size of perforations formed in the stencil sheet of the present invention by removal of the filler is very fine, an excessive passage or dislocation of an ink can be suppressed and thus excellent printed images having no setoff can be obtained when stencil printing is carried out by using a stencil plate prepared from the stencil sheet.

### BEST MODE FOR CARRYING OUT THE INVENTION

The stencil sheet of the present invention comprises a sheet having a large number of minute perforations, and the minute perforations are filled with (i) a resin having a melting point lower than that of the sheet, (ii) a resin soluble in a solvent, or (iii) a heat adhesive resin, as filler.

The sheet used in the present invention and having a large number of minute perforations is not especially limited so far as the sheet has a large number of minute holes which are perforated from the surface of one side to that of the other side thereof and through which an ink can be forced to pass. For example, a synthetic resin film, sponge rubber sheet, or foamed synthetic resin sheet each having minute holes formed therein can be used.

As the synthetic resin described above, a film forming synthetic resin is used, and for example, a crystalline thermoplastic resin heretofore known such as a polyester, polyvinylidene chloride, polyethylene, polypropylene, and polystyrene can be employed. From the viewpoint of productivity, a polyester, particularly a polymer of ethylene terephthalate, butylene terephthalate, or hexamethylene terephthalate, or a copolymer of the terephthalate with another component is preferably used.

As the sponge rubber, a natural rubber or a various kind of synthetic rubber can be used. As the foamed synthetic resin, a polyurethane foam, polyethylene foam, or the like can be used.

The thickness of the sheet described above is preferably 1.5 to 20 μm and more desirably in the range of 2 to 15 μm from the viewpoints of the strength as a stencil sheet, easiness of forming minute perforations, and production cost.

A large number of minute perforations in the sheet described above are preferably formed uniformly over whole surface of the sheet from the viewpoint of the reproducibility of accurate images. The area fraction of the opening portions of the minute perforations is preferably in the range of 20 to 70%, more preferably in the range of 25 to 65%, and still more desirably in the range of 30 to 60%. When the area fraction mentioned above exceeds 70%, an ink readily passes through the perforations, setoff is easily caused in printed materials, and printed images is liable to bleed. On the other hand, when the area fraction mentioned above is lower than 20%, passability of ink is poor, and printed images sometimes become thin to lower their definition. The term “area fraction of the opening portions of the minute perforations” means the area occupied by the opening portions expressed by percentage when a certain area of a sheet is placed horizontally and observed.

The size of the minute perforations is preferably in the range of 5 to 200 μm, more preferably 10 to 100 μm, and still more desirably in the range of 15 to 50 μm in terms of the diameter of equivalent circle when the opening portions of the minute perforations are assumed to be circular in shape. When the diameters of equivalent circles exceed 200 μm, an ink readily passes through the perforations, setoff is easily caused in printed materials, and printed images sometimes bleed. On the other hand, when the diameters of equivalent circles are smaller than 5 μm, passability of ink is poor, and printed images sometimes become thin to reduce their definition.

In the case where the sheet is a synthetic resin film, the minute perforations can be formed by pressing a roller having drill-like projections formed on its surface against the surface of the film under a heated condition. Specifically, a heated roller can be used or a roller can be pressed against a film while being heated. While the shape and size of the minute perforations can freely be fixed by the shape and size of the projections, it is preferable to use drill-like projections so that vertical cross sections of the perforations to be formed become trapezoidal. By making the vertical cross sections of the minute perforations trapezoidal and by arranging the film so that the film surface on which opening portions having smaller diameters of the perforations are opened, contacts with an object to be printed, control of the amount of an ink to be dislocated to the object becomes easy and setoff can efficiently be avoided.

In the case of a sponge rubber sheet and a foamed synthetic resin sheet, small holes which exist from the beginning and are connected in the sheet itself serve as the minute perforations, but the same method as that in the case of a synthetic resin film described above can be applied to obtain uniform minute perforations.

While the filler used in the present invention is a resin having a melting point lower than that of the sheet described above, a resin soluble in a solvent, or a heat adhesive resin, another component such as a dye and pigment can be included in the filler in a range in which achievement of the objects of the present invention are not prevented.

By using, as filler, a resin having a melting point lower than that of the sheet, it becomes possible to perforate under a heated condition by a small amount of energy. For instance, when a polyethylene terephthalate film is used as the sheet, for example, a polyvinyl acetate or a copolyester prepared by copolymerizing another monomer or reaction component at the time of polymerization of ethylene terephthalate can be used as low melting point resin. As the another monomer or reaction component, a dicarboxylic acid such as isophthalic acid, adipic acid, and dimeric acid, a low molecular weight glycol such as diethylene glycol and butanediol, and a polyalkeylene glycol such as polyethylene glycol and polytetramethylene glycol can be used.

The resin filled in the minute perforations is heated to melt by adding heat energy thereto, for example, by flash radiation with a halogen lamp, xenone arc lamp, or flash lamp, infrared radiation, pulse radiation of laser light, or the use of a thermal head, thereby forming minute perforations (that is, holes through which an ink is forced to pass) corresponding to letters or pictures in a manuscript. The amount of heat energy added in this step is adjusted to that in which a sheet such as a synthetic resin film is not melted.

In the case in which a resin which is soluble in a solvent is used as filler, considerable reduction of the energy to be used for perforating can be devised since the sheet can be perforated by applying or adding a solvent (the term “solvent” as used herein includes a solution) which dissolves the resin to the sheet without adding heat energy at the step of perforating. As the resin which is soluble in a solvent, for example, a water soluble resin such as a polyvinyl alcohol, methyl cellulose, carboxymethyl cellulose, hydroxyethyl cellulose, polyvinyl pyrrolidone, copolymer of ethylene with vinyl alcohol, polyethylene oxide, polyvinyl ether, polyvinyl acetal, polyacrylamide, starch, dextrin, alginic acid, ascorbic acid, and water soluble polyurethane can be used. Further, a resin such as a polyethylene, polypropylene, polyisobutylene, polystyrene, polyvinyl chloride, polyvinylidne chloride, polyvinyl fluoride, polyvinyl acetate, acrylic resin, polyamide, polyimide, polyester, polycarbonate, and polyurethane all of which are soluble in a solvent can be used. These resins may be used alone or in combination of two or more resins, or used as a copolymer.

As the solvent which dissolves the resin described above to perforate, a solvent such as hexane, heptane, octane, benzene, toluene, and xylene in addition to water, methyl alcohol, ethyl alcohol, isopropyl alcohol, n-propyl alcohol, ethylene glycol, diethylene glycol, propylene glycol, glycerine, acetone, methylethyl ketone, tetrahydrofuran, 1,4-dioxane, formic acid, acetic acid, propionic acid, formaldehyde, acetaldehyde, methyl amine, ethylene diamine, and pyridine can be used alone or in combination. Besides, a dye, pigment, antiseptic agent, wetting, and the like can be included in the solvent used for perforating, when necessary.

When the resin which is described above and filled in the minute perforations is dissolved by the solvent described above to form perforations, a member such as a dropping pipette, syringe, brush, and stamp, a writing utensil such as a fountain pen, ball-point pen, and marking pen, a device such as an ink-jet printer, and the like can be used.

As a material for the sheet such as a synthetic resin film in this case, it is preferable to select a material which has an excellent resistance to the solvent used for dissolving the filler and, for example, a high-density polyethylene and polyvinylidene chloride are preferably used.

Further, when a heat adhesive resin is used as filler, minute perforations are formed in a sheet by first placing a manuscript on which letters or pictures are drawn by a PPC toner or the like, on the sheet, pressing the sheet and manuscript against each other while heating by using heating means such as a heated roller and iron to heat adhere the heat adhesive resin filled in minute perforations located at the positions corresponding to those of the letters or pictures on the manuscript, to the letters or pictures, and then separating the manuscript from the sheet and removing the filler at the positions corresponding to those of the letters or pictures at the same time. As a heat adhesive resin in this case, a polyolefin resin, polyester resin, epoxy resin, polyamide resin, styrene-acrylonitril copolymer resin, ethylene-vinyl acetate copolymer resin, butyral resin, and the like can be used.

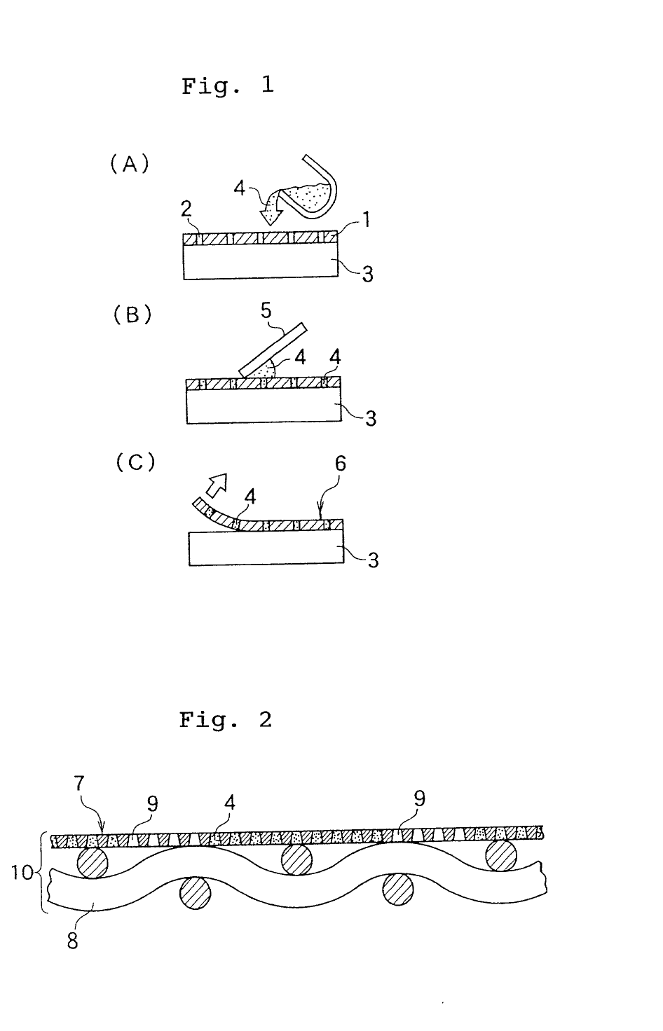

Filling of a filler in minute perforations in a sheet can be performed, for instance, by the steps (A), (B), and (C) shown in FIG. 1. In these steps, for instance, as shown in (A), synthetic resin film 1 having minute perforations 2 formed therein is first placed on polypropylene sheet 3, a solution, emulsion, or the like (hereinafter sometimes referred to only as solution for brevity) of filler 4 is spread or coated on the synthetic resin film 1, and then the solution of the filler 4 is squeezed with squeegee 5 to force the solution into the minute perforations 2 as shown in (B). Subsequently, as shown in (C), the solution of filler 4 is solidified and then synthetic resin film 1 is peeled off the polypropylene sheet 3 to obtain stencil printing sheet 6 of the present invention.

In the present invention, while a sheet having minute perforations in which the filler described above is filled can be used by itself as a stencil sheet, the sheet may be used as a stencil sheet after laminating a porous support such as a known tissue paper, non-woven fabric, and screen gauze on the surface of one side of the sheet. Lamination of the sheet with the porous support can be performed, for instance, by a method in which the sheet and the porous support are adhered through an adhesive or adhered by pressing them against each other under a heated condition. In this connection, a screen gauze comprising composite fibers of a sheath-core structure prepared by using a synthetic resin component having a low melting point for sheath portion may be used as the porous support.

FIG. 2 is a schematic drawing for illustrating the cross section of another example the stencil sheets of the present invention.

In FIG. 2, stencil sheet 10 is composed of synthetic resin film 7 and porous support 8 laminated on one side of the synthetic film 7, the synthetic resin film 7 has a large number of minute perforations having a trapezoidal vertical cross section uniformly over whole surface of the film, and filler 4 is filled in the minute perforations. In FIG. 2, 9 is a perforation (hole through which an ink is forced to pass) formed by adding heat energy to the filler with a heating element of a thermal head not shown in FIG. 2 to melt the filler.

When a stencil plate from such a stencil sheet is used, it is easy to prevent an ink from being excessively supplied to an object to be printed (which object is not shown in FIG. 2) and the setoff can be prevented in turn, since an ink is supplied from the side of the porous support in the stencil sheet at the time of printing and the printing ink is transferred to the object to be printed through perforations 9 in synthetic resin film 7.

### EXAMPLES

Now, the present invention will be described in more detail with reference to Examples. However, it should be understood that the scope of the present invention is by no means restricted by such specific Examples.

In the Examples, the area fraction of the opening portion of the minute perforations is shown by the mean value (arithmetic mean value) of the area fractions for 10 measuring points freely selected each of which area fractions is obtained by directly observing a sample sheet having minute perforations by bright-field transmission method using an optical microscope and determining the area fraction by using a picture processor which can cope with a high-quality monitor for high-definition TV set and was produced by Pierce Corp., at a monitor magnification of 240. The diameter of equivalent circle is shown by the mean value of diameters of equivalent circles for 10 measuring points freely selected each of which diameters of equivalent circles is obtained by first determining the diameter of an equivalent circle for a picture on the processor, reversing the black and white of the picture, determining the diameter of an equivalent circle for the reversed picture, and then arithmetically averaging the diameters thus determined.

### Example 1

A heated roller at 150° C. having drill-like projections diameter of which tapers down to a tip and is 40 μm at its smallest portion was pressed against a polyethylene terephthalate (PET) film having a thickness of 3 μm to form minute perforations therein. Vertical cross section of the minute perforations thus formed was trapezoidal, and the area fraction of the openings on the surface at the side of smaller diameter was 35% and its diameter of equivalent circle was 42 μm. Further, the area fraction of the openings on the surface at the side of larger diameter was 45% and its diameter of equivalent circle was 48 μm. Subsequently, a vinyl acetate resin was filled in the minute perforations formed in the film by the method shown in FIG. 1 to obtain a stencil sheet of the present invention.

After this stencil sheet was subjected to perforation with a thermal head to obtain a stencil plate, the stencil plate was loaded on a stencil printing machine, Risograph GR 375 (trade name) produced by RISO KAGAKU CORPORATION such that the surface of the side having openings of smaller diameter contacts with a printing paper, and stencil printing was carried out to obtain excellent printed matters.

### Example 2

Procedures for preparing a stencil sheet in Example 1 were repeated to obtain another stencil sheet with the exception that styrene-acrylonitrile copolymer (a heat adhesive or heat fusible resin) was used as filler.

A manuscript of PPC toner was placed upon the surface of the stencil sheet having openings of larger diameter and pressed against the stencil sheet with a heated roller at 100° C. Subsequently, the PPC toner manuscript was peeled off the stencil sheet to perforate, thereby forming a stencil plate. Thereafter, the stencil plate was loaded on a stencil printing machine, Risograph GR 375 (trade name) produced by RISO KAGAKU CORPORATION such that the surface of the stencil plate having openings of smaller diameter contacts with a printing paper, and stencil printing was carried out to obtain excellent printed matters.

### Example 3

Procedures for preparing a stencil sheet in Example 1 were repeated to obtain still another stencil sheet with the exception that a polyvinyl alcohol (a water soluble resin) was used as filler.

Water was added by an ink jet method to the stencil sheet thus obtained to form perforations, thereby forming a stencil plate, and then the stencil plate was loaded on a simple printing machine, Print Gokko (trade name) produced by RISO KAGAKU CORPORATION such that the surface having openings of smaller diameter contacts with a printing paper, and stencil printing was carried out while supplying an oil ink to obtain excellent printed matters.

A stencil sheet of the present invention can be perforated at a high sensitivity, without dependence on the thickness of a sheet such as a synthetic resin film as opposed to conventional sheets, even by a small amount of energy while maintaining a required strength, because a stencil plate can be prepared by filling a filler having a prescribed characteristic different from that of the sheet in a large number of minute perforations through which an ink can be forced to pass, formed in a stencil sheet, and then removing the filler only at the portions corresponding to printed images of a manuscript; and a stencil plate obtained from the stencil sheet is easy to control the amount of an ink to be dislocated to an object to be printed and has such an advantage that setoff is small, printability and definition of printed images are excellent, jamming is not caused, and wrinkles are not formed when stencil printing is performed by using the stencil plate. Further, when a stencil sheet of the present invention is used, simplification of a perforating machine can be devised since perforating can be carried out by a small amount of energy.

1. A stencil sheet comprising a sheet having a large number of minute perforations, said minute perforations being filled with the following resin (A), (B), or (C) as filler.
(A) a resin having a melting point lower than that of said sheet
(B) a resin which is soluble in a solvent
(C) a heat adhesive resin

2. The stencil sheet according to claim 1 wherein said sheet is a film of a synthetic resin.

3. The stencil sheet according to claim 1 or 2 wherein the area fraction of the opening portions of said minute perforations is in the range of 20 to 70% and the diameters of equivalent circles are in the range of 5 to 200 μm when the opening portions are assumed to be circular in shape.

4. The stencil sheet according to claim 1 or 2 wherein said minute perforations in said sheet are trapezoidal in vertical cross section.

5. The stencil sheet according to claim 1 or 2 wherein the thickness of said sheet is in the range of 1.5 to 20 μm.

6. The stencil sheet according to claim 1 or 2 wherein said stencil sheet further comprises a porous support laminated on one side of said sheet.

7. A process for producing a stencil sheet comprising pressing a roller having drill-like projections formed on its surface against a film of a synthetic resin to form minute perforations and then filling said minute perforations with a filler.

8. The process for producing a stencil sheet according to claim 7 wherein filling of said minute perforations with said filler is performed by applying a solution or emulsion of a resin as filler on said film of a synthetic resin having minute perforations formed therein, squeezing the solution or emulsion with a squeegee to force it into said minute perforations, and then solidifying the solution or emulsion of the resin.

9. The process for producing a stencil sheet according to claim 7 or 8 wherein the process further comprises laminating a porous support on one side of said film after a roller having drill-like projections formed on its surface was pressed against said film of a synthetic resin to form minute perforations and said minute perforations were filled with said filler or resin.

10. The process for producing a stencil sheet according to claim 7 or 8 wherein said filler or resin is selected from the group consisting of the following resins (A), (B), and (C).
(A) a resin having a melting point lower than that of said film
(B) a resin which is soluble in a solvent
(C) a heat adhesive resin

11. The process for producing a stencil sheet according to claim 7 or 8 wherein said film has an area fraction of the opening portions of said minute perforations in the range of 20 to 70% and diameters of equivalent circles in the range of 5 to 200 μm when the opening portions are assumed to be circular in shape.

12. The process for producing a stencil sheet according to claim 7 or 8 wherein the minute perforations in said film are trapezoidal in vertical cross section.

13. The process for producing a stencil sheet according to claim 7 or 8 wherein said film has a thickness in the range of 1.5 to 20 μm.

14. A process for producing a stencil plate comprising subjecting a stencil sheet
which was obtained by pressing a roller having drill-like projections formed on its surface against a film of a synthetic resin to form minute perforations and then filling said minute perforations with the following resin (A), (B), or (C) as filler
(A) a resin having a melting point lower than that of said film
(B) a resin which is soluble in a solvent
(C) a heat adhesive resin
to the following treatment (a), (b), or (c) according to said resin used, respectively, so that said resin in said minute perforations only at the portions corresponding to the printed images in a manuscript are removed from said film.
(a) When said resin is (A), an amount of heat energy is added to the surface of said film of the stencil sheet to melt said resin.
(b) When said resin is (B), a liquid which dissolves said resin is applied or added onto the surface of said film of the stencil sheet to dissolve said resin.
(c) When said resin is (C), a manuscript is pressed against the surface of said film of the stencil sheet while being heated to adhere said resin to the manuscript.
